(19) United States
(12) Patent Application Publication
(10) Pub. No.: US 2012/0317594 A1
(43) Pub. Date: Dec. 13, 2012

(54) METHOD AND SYSTEM FOR PROVIDING AN IMPROVED AUDIO EXPERIENCE FOR VIEWERS OF VIDEO

(75) Inventors: Ola Thorn, Limhamn (SE); Par-Anders Aronsson, Malmo (SE); Martin Ek, Dalby (SE); Magnus Jendbro, Staffenstorp (SE); Magnus Landqvist, Lund (SE); Par Stenberg, Veberod (SE)

(73) Assignee: SONY MOBILE COMMUNICATIONS AB, Lund (SE)

(21) Appl. No.: 13/503,061

(22) PCT Filed: Apr. 21, 2011
(86) PCT No.: PCT/IB2011/000886

§ 371 Date: Aug. 31, 2012

(51) Int. Cl. H04N 21/24

(52) U.S. Cl. 725/18

(57) ABSTRACT

A method and system for enhancing audio for a viewer watching digital video with sound, such as a movie or video game. The method and system determine where in the scene (40) the viewer's attention is focused, correlate the viewer's focal region with one of a plurality of regions (42a-d) of the video scene (40), preferably associated with a depth map, and enhance the sound corresponding to the focal region of the scene (40) as compared to the sound corresponding to the non-focal regions of the scene (40).

### TECHNICAL FIELD OF THE INVENTION

The present invention relates to sound reproduction, and more particularly to methods and systems for generating an improved an audio experience for viewers of video, such as a movie or video game, particularly when viewed on a portable electronic device.

### DESCRIPTION OF THE RELATED ART

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera (still and/or video), an Internet browser for accessing news and information, an audiovisual media player, a messaging device (text, audio, and/or visual messages), a gaming device, a personal organizer, and have other functions as well. Contemporary portable electronic devices, therefore, commonly include media player functionality for playing audiovisual content.

Generally as to audiovisual content, there have been improvements to the audio portion of such content. In particular, three-dimensional (“3D”) audio may be reproduced to provide a more realistic sound reproduction. Surround sound technologies are known in the art and provide a directional component to mimic a 3D sound environment. For example, sounds that appear to come from the left in the audiovisual content will be heard predominantly through a left-positioned audio source (e.g., a speaker), sounds that appear to come from the right in the audiovisual content will be heard predominantly through a right-positioned audio source, and so on. In this manner, the audio content as a whole may be reproduced to simulate a realistic 3D sound environment.

To generate surround sound, sound may be recorded and encoded in a number of discrete channels. When played back, the encoded channels may be decoded into multiple channels for playback. Sometimes, the number of recorded channels and playback channels may be equal, or the decoding may convert the recorded channels into a different number of playback channels. The playback channels may correspond to a particular number of speakers in a speaker arrangement. For example, one common surround sound audio format is denoted as “5.1” audio. This system may include five playback channels which may be (though not necessarily) played through five speakers—a center channel, left and right front channels, and left and right rear channels. The “point one” denotes a low frequency effects (LFE) or bass channel, such as may be supplied by a subwoofer. Other common formats provide for additional channels and/or speakers in the arrangement, such as 6.1 and 7.1 audio. With such multichannel arrangements, sound may be channeled to the various speakers in a manner that simulates a 3D sound environment. In addition, sound signal processing may be employed to simulate 3D sound even with fewer speakers than playback channels, which is commonly referred to as “virtual surround sound”.

For a portable electronic device, 3D sound reproduction has been attempted in a variety of means. For example, the device may be connected to an external speaker system, such as a 5.1 speaker system, that is configured for surround sound or other 3D or multichannel sound reproduction. An external speaker system, however, limits the portability of the device during audiovisual playback. To maintain portability, improved earphones and headsets have been developed that mimic a 3D sound environment while using only the left and right ear speakers of the earphones or headset. Such enhanced earphones and headsets may provide a virtual surround sound environment to enhance the audio features of the content without the need for the numerous speakers employed in an external speaker surround sound system.

External speaker systems, or 3D-enhanced portable earphones and headsets, often prove sufficient when the audiovisual content has been professionally generated or otherwise generated in a sophisticated manner. Content creators typically generate 3D audio by recording multiple audio channels, which may be recorded by employing multiple microphones at the time the content is created. By properly positioning the microphones, directional audio components may be encoded into the recorded audio channels. Additional processing may be employed to enhance the channeling of the multichannel recording. The audio may be encoded into one of the common multichannel formats, such as 5.1, 6.1, etc. The directional audio components may then be reproduced during playback provided the player has the appropriate decoding capabilities, and the speaker system (speakers, earphones, headset, etc.) has a corresponding 3D/multichannel surround sound or virtual surround sound reproduction capability.

While the goal of 3D/multichannel surround sound or virtual surround sound is generally to create the most realistic experience for the viewer, none of these described systems account for the viewer's perception of the content.

### SUMMARY

Accordingly, there is a need in the art for a methodology and system for producing enhanced realistic audio accompanying video content. In particular, there is a need in the art for an improved method and system for providing enhanced audio based on feedback from the viewer, such as by tracking the viewer's eyes to determine the portion of the video that has the viewer's focus.

According to one aspect of the invention, a method is provided for an improved audio experience for a viewer of video. The method may include receiving input data associated with a viewer's focus; identifying a focal region of the video corresponding the viewer's focus; selecting at least one focal audio component corresponding to the focal region; and enhancing the selected focal audio component with respect to at least one non-focal audio component corresponding to a non-focal region of the video. Enhancing the selected focal audio component with respect to the at least one non-focal audio component may include improving the viewer's perception of the selected focal audio component. Enhancing the selected focal audio component with respect to the at least one non-focal audio component also may include reducing the viewer's perception of the at least one non-focal audio component.

According to one aspect of the invention, identifying a focal region of the video corresponding the viewer's focus may include determining an area of a display that has a viewer's focus and determining a focal region of the video corresponding to the focus area.

According to one aspect of the invention, multiple focal regions are identified and multiple focal audio components are enhanced.

According to one aspect of the invention, the method may include defining a plurality of regions and associating a video scene with the plurality of regions. The regions may be defined based on one or more of: the display, the content of the video scene, the identified focal region, or a standard grid. The regions may also be selected based on the video scene. The plurality of regions also may correspond to regions of a depth map.

According to one aspect of the invention, the focal region and the non-focal region correspond to different regions of a depth map.

According to one aspect of the invention, the method may further include associating audio components and areas of video with regions of a depth map.

According to one aspect of the invention, the method may further include mixing the audio components associated with the focal region and the non-focal regions to generate two channel audio.

According to one aspect of the invention, input data associated with a viewer's focus is obtained using eye tracking technology.

According to one aspect of the invention, the method may further include automatically returning the audio components to their pre-enhanced states. Returning the audio components to their pre-enhanced states may be triggered by at least one of the following: a change of scene; a change in the viewer's focus; a decrease in levels of the audio component associated with the focal region; or elapsed time.

According to another aspect of the invention, a method is provided for improved audio experience for a viewer of video. The method may include associating a video scene with a depth map having a plurality of regions; associating a plurality of audio components with the plurality of regions of the depth map; tracking at least one of the viewer's eyes to determine the viewer's focal region of the depth map; and increasing the level of at least one audio component associated with the focal region compared to the level of an audio component associated with a non-focal region of the depth map.

According to one aspect of the invention, the regions may be defined based on one or more of: the display, the content of the video scene, the identified focal region, or a standard grid.

According to one aspect of the invention, the audio components associated with the focal region and the non-focal regions may be mixed to generate two channel audio.

According to another aspect of the invention, a system for an improved audio experience for a viewer of video is provided. The system may include a display screen for displaying video having a plurality of regions; a viewer monitor digital camera having a field of view directed towards the viewer; a focus determination module adapted to receive a sequence of images from the viewer monitor digital camera and determine which region video being displayed on the display screen has the viewer's focus; and an audio enhancement module adapted to select at least one focal audio component corresponding to the focal region of the video and enhance the selected focal audio component with respect to at least one non-focal audio component corresponding to a non-focal region of the video.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic diagram of an exemplary electronic device for use in accordance with an embodiment of the present invention;

FIG. 2 is a functional block diagram of operative portions of the exemplary electronic device of FIG. 1;

FIGS. 3A-3B are exemplary schematic block diagrams the device of FIG. 1 in operation according to the present invention;

FIGS. 4A-4C illustrate exemplary regions of a video scene, including the focal region of a viewer of the scene; and

FIG. 5 depicts an exemplary methodology for enhancing audio according to an embodiment of the present invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

The present invention provides an enhanced audio experience for viewers of digital video. Unlike prior technologies, the present invention responds to viewer feedback to optimize the audio during video playback. In a presently preferred embodiment, eye tracking technology is used to provide the viewer feedback, such as by determining what part of a display, and hence what part of a video scene, the viewer is focusing on. Once the viewer feedback is obtained, the audio corresponding to the part of the scene that has the viewer's focus is enhanced to increase the viewer's perception. Thus, just like in a real world situation, the present invention permits a viewer to focus his attention on sounds emanating from one location to increase perception of those sounds while sounds emanating from outside the viewer's focal location become less perceived. In this manner, the audio playback is perceived by the viewer more realistically.

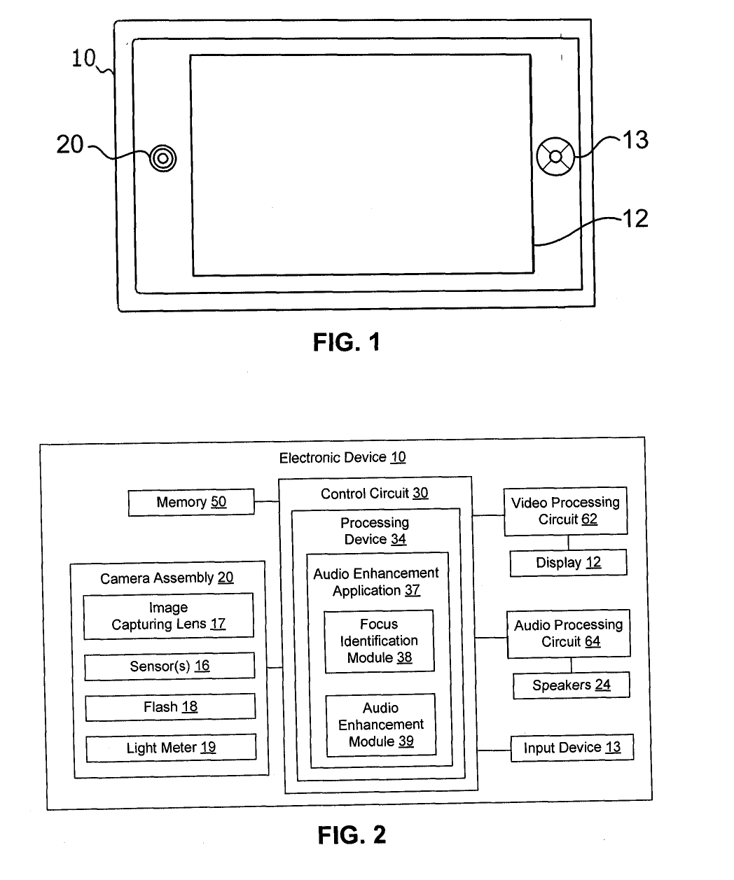

With reference to FIG. 1, an exemplary electronic device 10 is embodied in a portable electronic device having a digital video function. It will be appreciated that the term “digital video” as used herein includes audiovisual content that may include a video portion and an audio portion. The exemplary portable electronic device 10 may be any type of appropriate electronic device or combination of devices capable of displaying digital video and receiving viewer feedback, which may be manual or automated. Such devices include but are not limited to mobile phones, digital cameras, digital video cameras, mobile PDAs, other mobile radio communication devices, gaming devices, portable media players, or the like. It will also be appreciated that the present invention is not limited to portable devices and may embodied in computers, including desktops, laptops, tablets and the like, as well as in television and home theater settings.

FIG. 1 depicts various external components of the exemplary electronic device 10, and FIG. 2 represents a functional block diagram of operative portions of the electronic device 10. The electronic device 10 may include a display 12, which may be a touch sensitive display, a camera assembly 20, and may further include additional user interface devices 13, such as a directional pad or other buttons.

Electronic device 10 may include a primary control circuit 30 that is configured to carry out overall control of the functions and operations of the electronic device. The control circuit 30 may include a processing device 34, such as a CPU, microcontroller or microprocessor. Among their functions, to implement the features of the present invention, the control circuit 30 and/or processing device 34 may comprise a controller that may execute program code embodied as the audio enhancement application having a focus identification module 38 and audio enhancement module 39. It will be apparent to a person having ordinary skill in the art of computer programming, and specifically in application programming for cameras and electronic devices, how to program an electronic device to operate and carry out logical functions associated with application 37. Accordingly, details as to specific programming code have been left out for the sake of brevity. Also, while the code may be executed by control circuit 30 in accordance with an exemplary embodiment, such controller functionality could also be carried out via dedicated hardware, firmware, software, or combinations thereof, without departing from the scope of the invention.

Electronic device 10 also may include a camera assembly 20. The camera assembly 20 constitutes an image generating device for generating a digital image, such as digital still photographs or digital moving video images. The camera assembly 20 may include a lens 17 that faces outward toward the viewer, such as the type used for video chat. Camera assembly 20 may also include one or more image sensors 16 for receiving the light from the lens 17 to generate images. Camera assembly 20 may also include other features common in conventional digital still and video cameras, such as a flash 18, light meter 19, and the like.

Electronic device 10 has a display 12 which displays information to a viewer regarding the various features and operating state of the electronic device, and displays visual content received by the electronic device and/or retrieved from a memory 50. Display 12 may be used to display pictures, video, and the video portion of multimedia content. In the presently preferred embodiment, display 12 is used to display video, such as that associated with a movie, television show, video game or the like. The display 14 may be coupled to the control circuit 30 by a video processing circuit 62 that converts video data to a video signal used to drive the various displays. The video processing circuit 62 may include any appropriate buffers, decoders, video data processors and so forth. The video data may be generated by the control circuit 30, retrieved from a video file that is stored in the memory 50, derived from an incoming video data stream, or obtained by any other suitable method. In accordance with embodiments of the present invention, the display 12 may display the video portion of media played by the electronic device 10.

The electronic device 10 further includes an audio signal processing circuit 64 for processing audio signals. Coupled to the audio processing circuit 64 are speakers 24. One or more microphones may also be coupled to the audio processing circuit 64 as is conventional.

It should be understood that while the electronic device 10 includes a camera assembly 20, display 12 and control circuit 30, the display, camera and control circuitry may be embodied in separate devices. For example, the display may be embodied in a television, the camera may be embodied in a separate web cam or digital video camera and the control circuitry could be embodied in the television, the digital video camera or in a separate device, which could include a general purpose computer. Similarly, the speakers 24 need not be embodied in electronic device 10 and may be, for example, external speakers, virtual surround sound earphones, or a wired or wireless headset.

The present invention provides for the enhancement of audio associated with digital video based on the viewer's focus. For example, the camera assembly 20 may be used to track the viewer's eyes while the viewer is watching a video on the display 12. The focus identification module 38 may then use the images obtained from the camera to determine what portion of the display 12, and thus what portion of the video scene being displayed, has the viewer's focus. The audio enhancement module 39 may then enhance the audio associated with the portion of the video scene that has the viewer's focus to increase the viewer's perception of that portion of the scene.

As stated above, the focus identification module 38 and audio enhancement module each may be embodied as executable program code that may be executed by the control circuit 30. It will be apparent to a person having ordinary skill in the art of computer programming, and specifically in application programming for cameras, electronic devices, how to program an electronic device to operate and carry out logical functions associated with the focus identification module 38 or the audio enhancement module 39. Accordingly, details as to specific programming code have been left out for the sake of brevity. Also, while the code may be executed by control circuit 30 in accordance with an exemplary embodiment, such controller functionality could also be carried out via dedicated hardware, firmware, software, or combinations thereof, without departing from the scope of the invention. Furthermore, although the focus identification module 38 and audio enhancement module 39 have been described as being part of the audio enhancement application 37, the focus identification module 38, the audio enhancement module 39, or portions thereof may be independent of the audio enhancement application 37.

It will also be appreciated that the viewer's focus may be obtained by other means as well. For example, the display 12 may be touch sensitive and the control circuit 30 may include a viewer interface application that provides the viewer with customized options for touching a portion of the video scene during playback to enhance the associated audio. In addition, other user interface devices 13, e.g., a directional pad, could be used to permit the viewer to identify a region of the scene for enhanced audio. It will be apparent to a person having ordinary skill in the art of computer programming, and specifically in application programming for electronic devices, how to program an electronic device to operate and carry out logical functions associated with the focus identification module 38 in which the viewer's focus is obtained by non-camera means.

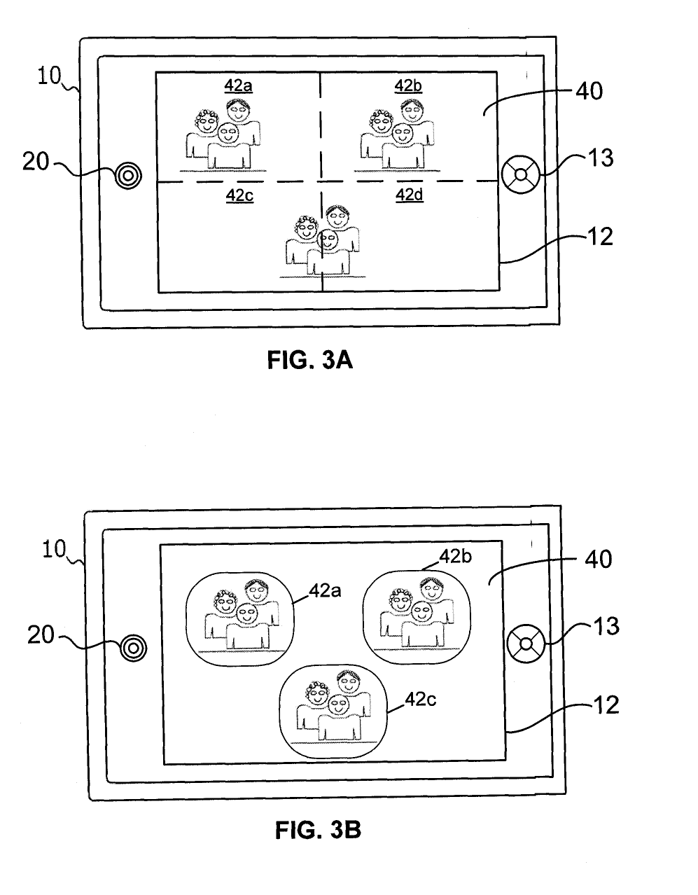

FIGS. 3A and 3B depict an exemplary video scene 40 on the display 12 of the electronic device 10. Preferably, the audio associated with the video scene 40 is multi-channel 3D audio. If not, two channel audio (stereo audio) may be converted to multi-channel surround 3D audio using known techniques. Additionally, the video scene 40 preferably has an associated depth map. For example, three dimensional video and computer games typically have z-values that can be used to create a depth map. If the video scene does not contain a depth map, one can be created using known techniques for converting two dimensional video to three dimensional video.

The scene 40 has multiple regions 42x, which may be defined based on the display 12, based on the scene 40, or based on the location of the display upon which the viewer is focused, or based on a standard grid. For example, as shown in FIG. 3A, the scene may be associated with multiple regions based on the display 12 independent of the content of the scene. In addition, as shown in FIG. 3B, the scene may be associated with multiple regions based on the content of the scene 40 independent of the video display. In either case, the regions may correspond to regions of a depth map. Moreover, it may be desirable to first determine the viewer's focus location and set the focal region as a region of the depth map surrounding the viewer's focus.

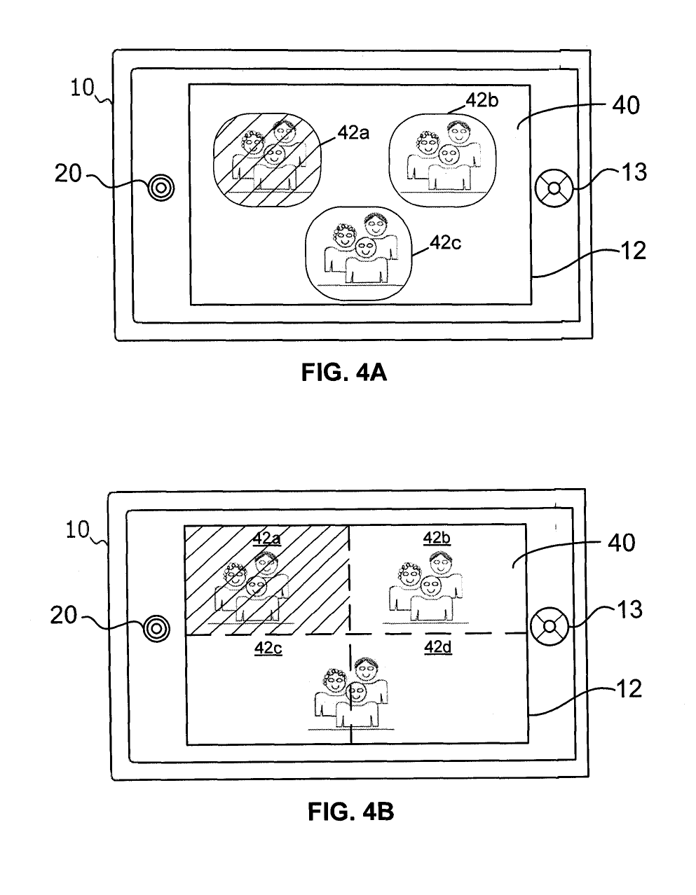

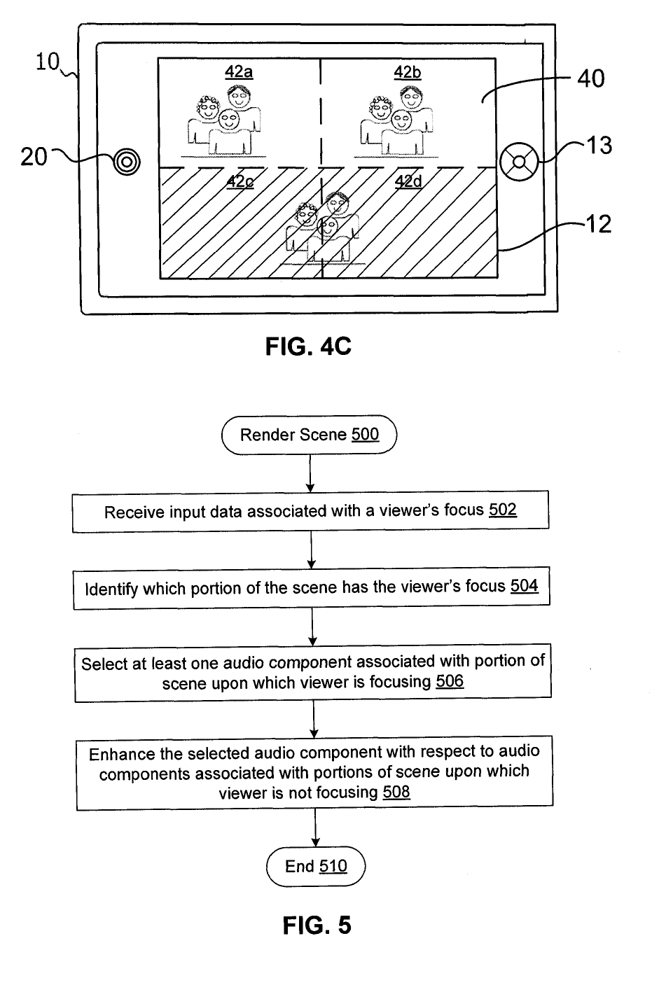

Turning next to FIGS. 4A-4C, exemplary regions of a video scene, including the focal region of a viewer of the scene, are illustrated. As shown in FIG. 4A, the viewer is focused on region 42a. It should be understood by those skilled in the art that regions 42a, 42b and 42c may be defined by, for example, the content of the scene 40. Also, as noted above, region 42a may be defined by the viewer's focus. Preferably, region 42a is associated with a depth map.

As shown in FIGS. 4B and 4C, the regions 42a-d may be defined by, for example, the display or a standard grid. In addition, particularly when the regions 42a-d are not defined by video content or the viewer's focus, it is possible that the viewer's focal region may overlap multiple of the regions 42a-d. For example, in FIG. 4B, the viewer's focus is on a first conversation in region 42a. In FIG. 4C, the viewer's focus is on a second conversation, part of which is in region 42c and part of which is in region 42d. Thus, it may be desirable to enhance at least one audio component associated with region 42c and at least one audio component associated with region 42d.

It will be appreciated by those skilled in the art that any various techniques, including automated eye tracking and manual viewer input, may be used to determine the viewer's focus. Manual viewer input can be accomplished using a touch sensitive display 12 or user input devices, such as a directional pad 13. Eye tracking can be accomplished by, for example, a camera, such as the camera assembly 20, using various technologies with ambient or infrared light. The invention is not limited to any specific method of eye tracking and any suitable eye tracking technology may be used. For example, bright pupil or dark pupil eye tracking may be used. Preferably, the eye tracking technology is capable of approximating the location of the viewer's focus on the display 12, which in turn may be correlated to a region of the video scene 40. In addition, to facilitate eye tracking, it may be desirable for the camera assembly 20 and display 12 to be embodied in a single electronic device 10 so that the relative position of the camera assembly 20 with respect to the display 12 is static.

In accordance with the above, FIG. 5 is a flow chart depicting an exemplary method of providing improved audio for a viewer of digital video. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method may begin at step 500 at which a digital video scene, such as the video scene 40, is rendered. Preferably, the video scene 40 has an associated with a depth map. Accordingly, the method may additionally include associating the video scene with a depth map, for example, prior to rendering the digital video scene at step 500. It should be understood by those skilled in the art that such processing may be accomplished by the control circuit 30, processing device 34, video processing circuit 62, or additional circuitry or processing device(s) not shown in FIG. 2. The plurality of regions may be defined, for example, based on the content of the video, the display 12 (e.g., the dimensions or pixels) or according to a standard grid. Preferably, each of the plurality of regions is associated with a depth map. In the case where the video scene is three-dimensional, z-value data may be used to associate the video with a depth map. For two-dimensional video, it may be desirable to convert the video to three-dimension video to facilitate depth map association as will be understood by those of skill in the art.

In addition, the digital video scene preferably has audio components that are associated with a depth map of the video scene. Thus, the audio components may be associated with the defined regions of the video scene and with a depth map. The audio components preferably include 3D multichannel audio components.

The method continues at step 502 at which input data associated with a viewer's focus is received. As discussed above, the input data may be in the form of eye tracking information, which include automatically generating digital images of the viewer's eye(s), or other types of input data, such as manual commands received through a touch screen or other viewer input mechanism as will be understood by those of skill in the art. For example, identifying a focal region of the video scene corresponding the viewer's focus may include determining an area of a display that has a viewer's focus and determining which region of the video scene corresponds to the focus area of the display. In addition, it may also be desirable to define one or more regions within the video scene based on the viewer's identified focus. For example, a focal region may be identified as a region of the scene including and immediately surrounding the viewer's identified focal area. In this manner, the focal region may be defined, for example, as a region centered around the viewer's focal area. The focal region may then be correlated with the video scene and audio components.

The method continues at step 504 at which a focal region of the video scene corresponding the viewer's focus is identified. Step 504 may be performed by the focus identification module 38 of the audio enhancement application 37. Preferably, the focal region and non-focal regions correspond to different regions of a depth map as described above. Step 504 may further include identifying multiple focal regions.

Flow progresses to step 506 at which at least one focal audio component corresponding to the focal region is selected. Multiple focal audio components may be associated with a single focal region. In addition, multiple focal regions may exist, and multiple focal audio components corresponding to the multiple focal regions may be selected.

The method continues at step 508 at which the selected focal audio component(s) is enhanced with respect to at least one non-focal audio component corresponding to a non-focal region. Enhancing the audio component may be performed by the audio enhancement module 39. Enhancing the selected focal audio component with respect to at least one non-focal audio component might include improving the viewer's perception of the selected focal audio component. In addition, enhancing the selected focal audio component with respect to at least one non-focal audio component also may include reducing the viewer's perception of the at least one non-focal audio component.

As will be understood by those of skill in the art, various techniques may be used to increase a viewer's perception of a selected audio component in a sound field of multiple audio components. For example, the level of the selected audio component may be increased with respect to audio components associated with non-focal regions. Also, the level of the audio components associated with the non-focal regions may be decreased with respect to the selected audio component. In addition, it may be preferable to enable the viewer to manually increase even further a selected audio component. This feature is easily implemented by enabling manual viewer input via a touch sensitive display 12 or user input devices, such as a directional pad 13. In addition, as will be understood by those skilled in the art, audio enhancement may include dynamic equalization, phase manipulation, harmonic synthesis of signals, harmonic distortion, or any other known technique for enhancing audio.

Additionally, the audio component(s) corresponding to the focal region may be combined with the audio components corresponding to the non-focal region and output. The audio components may be mixed to create multichannel three dimensional audio, or it may be preferably to mix the audio components to generate two channel audio, e.g., if the video scene is being played on an electronic device having two channel stereo speakers.

The method continues to termination block 510.

In addition, the present method also contemplates automatically returning the audio components to their pre-enhanced states, which may be triggered by a variety of events including: a scene change; a change of the viewer's focus; a decrease in levels of the audio component associated with the focal region; or elapsed time.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

1. A method for providing an improved audio experience for a viewer of video comprising:
receiving input data associated with a viewer's focus;
identifying a focal region of the video corresponding the viewer's focus;
selecting at least one focal audio component corresponding to the focal region; and
enhancing the selected focal audio component with respect to at least one non-focal audio component corresponding to a non-focal region of the video.

2. The method of any one of the preceding claims wherein enhancing the selected focal audio component with respect to the at least one non-focal audio component comprises improving the viewer's perception of the selected focal audio component.

3. The method of any one of the preceding claims wherein enhancing the selected focal audio component with respect to the at least one non-focal audio component comprises reducing the viewer's perception of the at least one non-focal audio component.

4. The method of any one of the preceding claims wherein enhancing the selected focal audio component with respect to the at least one non-focal audio component comprises adjusting levels of the audio components with respect to one another.

5. The method of any one of the preceding claims wherein identifying a focal region of the video corresponding the viewer's focus comprises determining an area of a display that has a viewer's focus and determining a focal region of the video corresponding to the focus area.

6. The method of any one of the preceding claims wherein multiple focal regions are identified and multiple focal audio components are enhanced.

7. The method of any one of the preceding claims further comprising defining a plurality of regions within a video scene.

8. The method of claim 7 wherein the regions are defined based on one or more of: the display, the content of the video scene, the identified focal region, or a standard grid.

9. The method of any one of claims 7-8 wherein each of the plurality of regions corresponds to a region of a depth map.

10. The method of any one of the preceding claims wherein the focal region and the non-focal region correspond to different regions of a depth map.

11. The method of any one of the preceding claims further comprising associating audio components and areas of video with regions of a depth map.

12. The method of any one of the preceding claims further comprising mixing the audio components associated with the focal region and the non-focal regions to generate two channel audio.

13. The method of any one of the preceding claims wherein input data associated with a viewer's focus is obtained using eye tracking technology.

14. The method of any one of the preceding claims further comprising automatically returning the audio components to their pre-enhanced states.

15. The method of claim 14 wherein returning the audio components to their pre-enhanced states is triggered by at least one of the following: a change of scene; change of the viewer's focus; a decrease in levels of the audio component associated with the focal region; or elapsed time.

16. A method for providing an improved audio experience for a viewer of video comprising:
associating a video scene with a depth map having a plurality of regions;
associating a plurality of audio components with the plurality of regions of the depth map;
tracking at least one of the viewer's eyes to determine the viewer's focal region of the depth map; and
increasing the level of at least one audio component associated with the focal region compared to the level of an audio component associated with a non-focal region of the depth map.

17. The method of claim 16 wherein multiple focal audio components are enhanced.

18. The method of any one of claims 16-17 wherein the regions are defined based on one or more of: the display, the content of the video scene, the identified focal region, or standard grid.

19. The method of any one of claims 16-18 further comprising mixing the audio components associated with the focal region and the non-focal regions to generate two channel audio.

20. A system for providing an improved audio experience for a viewer of video comprising:
a display (12) screen for displaying video having a plurality of regions (42a-d);
a viewer monitor digital camera (20) having a field of view directed towards the viewer;
a focus determination module (38) adapted to receive a sequence of images from the viewer monitor digital camera (20) and determine which region (42a-d) video being displayed on the display (12) screen has the viewer's focus; and
an audio enhancement module (39) adapted to select at least one focal audio component corresponding to the focal region of the video and enhance the selected focal audio component with respect to at least one non-focal audio component corresponding to a non-focal region of the video.
